(19) United States
(12) Patent Application Publication
(10) Pub. No.: US 2004/0148831 A1
(43) Pub. Date: Aug. 5, 2004

(54) Pole advertising device

(76) Inventor: Scott Basyl Johnston, Melbourne (AU)

Correspondence Address: Mr. Scott Johnston, Street Pole Advertising USA, 6012 Ross Drive, Woodridge, IL, 60517, US

(21) Appl. No.: 10/626,652

(22) Filed: Jul. 25, 2003

(30) Foreign Application Priority Data
Jul. 24, 2002 (AU) 2002950341

(51) Int. Cl. G09F 15/00

(52) U.S. Cl. 40/607.03; 40/606.18

(57) ABSTRACT

The present invention relates to a sign comprising two or more housings which are interlockingly connected together around a pole. Each housing has a selectively adjustable collar arrangement which can be adjusted to size to fit around the pole.

The present invention relates to signage and advertising in general, and to displaying of information. In particular, the present invention relates to a device and a method of installing a device which provides more attractive signage and information, including the display and/or presentation of advertisements and other useful information, particularly in a more efficient and/or environmentally pleasing manner. Even more particularly, the present invention relates to a one-size-fits-all type of sign which is adapted to be attached to a range of differently sized and shaped existing support structures, such as poles, posts or the like. Even more particularly, the present invention relates to a modular sign having one, two, three or more parts that optionally can be interconnected together, and which can be located around the periphery of an existing support structure, such as a pole, so as to surround the pole and be attached thereto so as to dispense with the need to provide a separate support structure specifically for supporting the sign. The present invention finds particular application as a sign or a housing for forming a sign in which the size of the housing can be quickly and easily adjusted to take into account the different sized poles to which the housing is to be attached to form the sign. In particular, the present invention relates to a modular road sign comprising a housing which is adapted to be fitted to or otherwise attached to an existing street pole or the like, in which the sign is provided with a selectively adjustable attachment, fitment, collar or the like so as to accommodate being fitted to any size pole or any diameter pole within reasonable limits.

Although the present invention will be described with particular reference to one form of the housing and to the sign formed from the housing, it is to be noted that the scope of the present invention is not restricted to the described embodiments but rather the present invention is broader in scope so as to encompass other devices, other methods and other applications than specifically referred to herein.

With increasing regulation of activities there is an increasing need to inform people and an increasing proliferation of notices, signs or other information conveying devices informing people of various facts and information. Each of these devices for conveying information needs to be supported in some way, such as for example traffic signs need to be supported by a pole or similar structure. It is to be noted that the word “sign” as used throughout this specification to refer to the device for conveying information is not intended to be limited to signs. The use of the term “sign” is not meant to be limiting in any way but rather the word “sign” is used for ease of description and understanding. The term “sign” includes within its scope any device for conveying information. Similarly, the information can be of a variety of types such as directions, safety notices, road signs, timetables, advertisements, warnings and the like. Again, for the sake of ease of description and understanding the word “indicia” will be used as a general term to refer to any information conveyed by the sign and related devices in all their forms.

Each sign containing indicia requires support. The usual manner for supporting such signs are posts, poles or other suitable support members or structures. This has led to a proliferation of poles in the environment merely for the sole purpose of supporting signs. The proliferation of poles is unsightly, which in turn leads to visual pollution and a street scape which is chaotic, crowded and visually unattractive as well as being environmentally damaging. Furthermore, the proliferation of poles and other supports at the roadside or nearby to roads is dangerous as there is a greater risk of motor vehicles coming into contact with the poles, thus causing injury to persons in close proximity, including the occupants of the motor vehicle, and damage to the surroundings, such as to the motor vehicle, the pole and other structures located nearby.

Additionally, owing to the crowding of the signs near to one another there is a tendency to overlook vital information provided by the signs as the signs are obscured by the positioning of other poles or posts or are located at locations which are difficult to see, including being obscured by other signs. Furthermore, the very number of signs each supported by its own individual pole or post makes it difficult to comprehend the information contained in all of the signs, particularly when driving.

Additionally, the numerous poles, each supporting a single sign, constitutes a safety hazard to road users, pedestrians and the like, as there is an increased risk of hitting one or more of the multitude of poles.

From all of the above there is a need to reduce the number of poles, posts or the like used to support individual signs containing indicia.

Owing to a variety of regulations and accepted conventions, signs are available in a wide variety of sizes, shapes and styles. Additionally, the poles supporting such signs come in a variety of shapes, sizes and styles. Thus, in the past it has not been easy to adapt the different shaped, sized and styled signs for use with the widely differing, shaped, sized and styled poles. Thus, the physical arrangement of the signs and supports has meant that it was difficult to support more than one sign on each pole. Thus, there is a need for a universal sign or at least a sign that can be attached to a wider variety of poles which sign can be adapted to fit a variety of differently sized and styled poles or posts in order to avoid the proliferation of poles and posts, particularly poles and posts for supporting a single sign only.

Therefore, it is an object of the present invention to provide a sign which can be made from a housing in which the housing is a one-size-fits-all type or is provided with a selectively adjustable collar that can be readily adapted for use with a variety of different sized poles, particularly poles having different diameters. Further, it is an aim of the present invention to provide a method of forming a sign or attaching a sign to a suitable support element where the sign is formed from a housing which can be quickly and easily altered to size to fit the required pole.

According to one aspect of the present invention there is provided a housing adapted for use as or in forming a sign for presenting or displaying indicia when attached to a support element, said housing including a contact portion allowing the housing to contact the support element in use to assist in forming the sign,

a display portion for displaying or presenting the indicia in use of the sign, and

a fastening means for fastening the housing to the support element, wherein the size of the contact portion is selectively adjustable to accommodate attaching the housing to differently sized and/or styled support elements.

According to another aspect of the present invention there is provided a housing adapted for use as or in forming a sign for presenting or displaying indicia when attached to a support element, said housing including a contact portion allowing the housing to contact the support element in use to assist in forming the sign,

a display portion for displaying or presenting the indicia in use of the sign, and

a cooperating means for cooperatively engaging with a complementary cooperating means of a backing member to further assist in attaching the housing to the support element to form the sign.

One example of the indicia displayed by the sign is information relating to transport systems, such as for example, traffic signs, public transport timetables for one or more routes or the like. Another example of the sign is a road and/or traffic sign conveying information to road users, such as advisory signs about restricted speed limits, hazards or the like. A still further example of the sign includes advertisements. However, it is to be noted that any indicia whatsoever can be presented by the sign.

Typically, the sign is made up of one, two, three, four or more separate housings located together around the periphery of the support element. More typically, the housings are interconnected together so as to more or less completely surround the support element. Preferably, the backing member is a housing, even more typically the backing member is provided with a display portion forming a sign in its own right. It is to be noted that a single housing can form one embodiment of the sign by being connected to the support member without benefit of a separate backing member or two or more separate parts of the sign can be interconnected together to form a double sided sign, triple sided sign or the like.

Typically, the contact portion is located either at or towards the top of the housing or at or towards the bottom of the housing or at or towards both the top and bottom of the housing. One form of the contact portion is a collar arrangement. Another form is a plurality of collars of different sizes arranged in stepped relationship to each other in increasing size from being relatively smaller to relatively larger. The collars may be formed integrally with the housing or may be separate from the housing and securely attached to the housing. More typically, the collars are generally arcuate, more typically part circular or curved in profile to fit around a cylindrical pole, post or the like. Even more typically, the inner side of the collars are circular or part circular in profile for contacting corresponding circular profiles of support lements or any other profiles of the support elements.

Typically, the individual collars can be cut or trimmed to size. Typically, the collars can be sized either longitudinally or transversely. More typically, the collars are cut to size to fit the support element or member to which the sign is attached. Even more typically, the individual collars are provided with one or more flange portions and one or more riser portions, preferably a single flange and a single riser portion.

Typically, the support elements are poles, such as for example, existing poles for carrying power lines, telephone lines, public transport power lines for trams, trolley buses or the like and similar support structures. Other forms of the poles include traffic sign poles. Even more typically, the poles are of a circular cross-section and/or are round poles made from any suitable materials such as metal, timber, plastics or the like. However, it is to be noted that the poles can be of any shape and that the collars are of a corresponding shape, particularly the inner profile of the collars.

Typically, the sign or display portion can be illuminated, either internally illuminated or externally illuminated. More typically, the sign is provided with an electronic display or read out. Even more typically, the sign is programmable to provide messages, directions and the like.

Typically, the display portion is a panel, board, section, segment or the like. More typically, the display portion is a planar section or substantially planar section provided on the body of the housing. More typically, the display panel is provided with a clear face or surface. More typically, the panel is a pocket into which is located a sheet containing the information displayed by the sign. Alternatively, the sign or other indicia is adhered directly to the flat display portion or section, either with a permanent adhesive or a releasable adhesive. The sign may be a permanent sign or a temporary sign, such as a road sign warning of a temporary hazard such as road works, water on the road or the like.

Typically, the display means is a panel either a flat panel or a curved panel. More typically, the indicia is applied directly to the panel, such as for example, as a weather resistant sheet of plastics material or other durable material. Even more typically, the sheet is adhered to the display panel by suitable adhesive.

Typically, the sign is provided with one, two, three, four or more display panels, each display panel having the same or different indicia. More typically, each housing is provided with a display panel. Even more typically, there is a combination of display panels within the one sign, such as for example, a combination of a flat panel and a curved panel.

Typically, the cooperating means allows two housings to be joined or interconnected together. Typically, the cooperating means includes two complementary parts which are interconnectable together or cooperatively engagable with each other to join two or more housings together. More typically, each housing is provided with both parts of the cooperating means, typically one part being located at or towards one side and the other part being located at or towards the other side.

Typically, the cooperating means includes a tab and slot arrangement or a tongue and groove arrangement, interlocking flange arrangement or the like.

Typically, the fastening means is an elongate flexible member or similar for fitting around the housings, typically the collar arrangement of the housing to assist in retaining the housing in place on the pole to form a sign.

Typically, the sign is provided with its own power. More typically, the power is provided by a photovoltaic device. Even more typically, the sign is solar powered by being provided with a solar panel. Typically, the solar panel provides power to illuminate the sign.

The present invention will now be described by way of example with reference to the accompanying drawings in which:

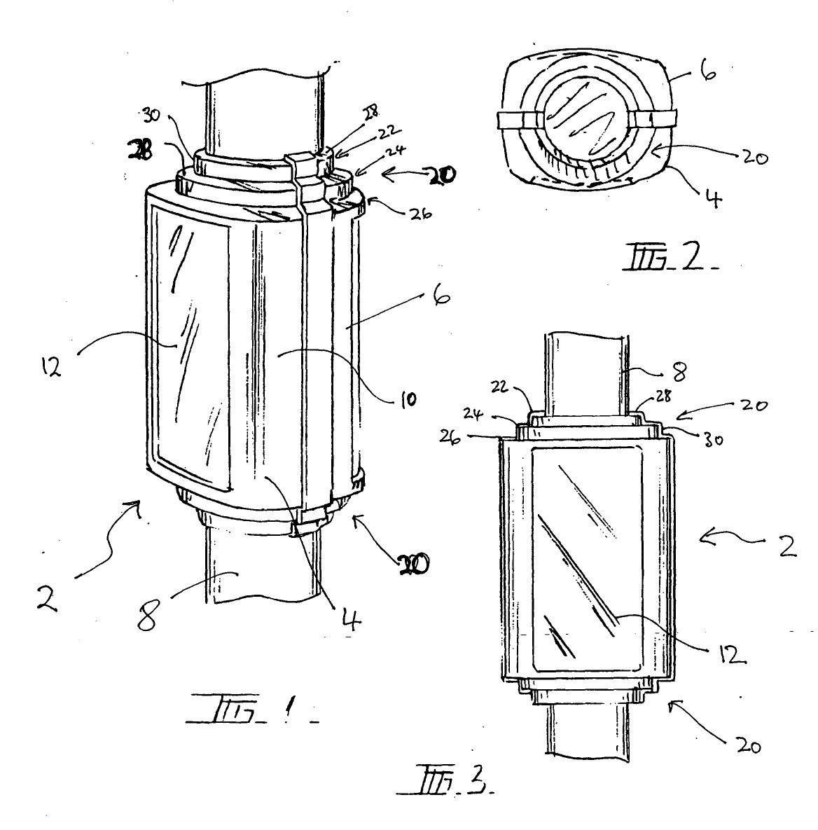

FIG. 1 is a top side perspective view of one form of a sign made from two interconnected housings in accordance with the present invention shown in situ attached to either side of a pole.

FIG. 2 is a horizontal cross-section looking down upon the sign of FIG. 1 showing the two housings interconnected together to form the sign.

FIG. 3 is a side elevational view of the sign of FIG. 1 showing the display panel of one housing for conveying information.

FIGS. 4 to 10 are each top-plan views of different alternative arrangements of the sign of the present invention formed from different numbers of various shaped housings interconnected together to form signs of different shapes, but omitting details of the cooperating means for interconnecting the housings together.

With particular reference to FIGS. 1 to 3 there is shown one form of the sign of the present invention, generally denoted as (2) formed from two interconnected housings (4), (6), typically a front housing 4 and a rear housing 6, attached to either side of a pole (8) and interconnected together so as to be securely attached to pole (8).

The embodiment of the sign shown in FIGS. 1 to 3 is formed by two substantially identical housings interconnected to each other along their respective side edges by suitable cooperating means. Although two separate interconnecting housings are necessary to form this embodiment of the sign, as the housings are identical only one of the housings will be described in detail. It is to be noted that minor variations can exist in the shape and features of the housing such as for example, differences in the cooperating means provided on each housing for interconnecting the housings together to form the sign.

Housing (4) includes a main body portion (10) which is of a generally semi-circular shape or distorted semi-circular shape so as to extend generally arcuately from one side of the pole to a diametrically opposed side of the pole, typically the sides of the pole when that pole is viewed from the usual viewing position of the pole. Thus, the two distorted semi-circular housings completely surround the pole when connected together. In the embodiment shown in FIGS. 1 to 3 the outer profile of the housing is generally semi-circular or substantially semi-circular or distorted semi-circular by having flat sections (12) or substantially flat sections at various locations around the periphery of the housing and curved sections at other locations around the periphery of the housing. However, it is to be noted that the outer profile can take any convenient shape, such as for example, one of the shapes as is shown in FIGS. 4 to 10. Body (10) is provided with a display portion (20) in the form of a solid flat display panel moulded in the housing or in the form of a clear window or face defining the outer surface of a pocket or similar for receiving therein a sheet of card, paper or plastics material upon which the information is provided to form the indicia displayed by the sign. The pocket is designed so that the sheet containing the indicia can be readily removed and replaced with a fresh sheet, such as for example, in the event that the sign is a temporary sign or a periodic sign. In one embodiment the pocket is accessible from outside whereas in other embodiments, the pocket is sealed from the outside to prevent tampering or damage to the sheet of indicia and access can be obtained from inside the housing, typically after temporarily removing the housing from the pole or post supporting it. In these embodiments the housings can be dismantled from the pole 8. Further it is to be noted that the display portion can take any suitable, desirable or convenient form.

In another embodiment the display panel is a flat section to which is adhered by a suitable adhesive, either a permanent adhesive or a releasable adhesive, a sheet of suitable material carrying the indicia.

A collar arrangement (20) is provided at or towards the top of the housing (4) and another collar arrangement 20 is located at or towards the bottom of housing (4), as shown particularly in FIGS. 1 and 3. Although a housing having a collar arrangement (20) at both the top and bottom is shown in the FIGS. 1 and 3, it is to be noted that in other embodiments there need only be one collar arrangement located at either the top or the bottom. Collar arrangement (20) in the embodiment depicted in FIGS. 1 to 3 is provided with three separate collar portions (22), (24) and (26) arranged in substantially parallel, substantially concentric, stepped relationship to each other having different radii. The stepped relationship allows one of the collar sections to be selected and the radius of curvature of the inner surface of the selected section to be cut to size to selectively adjust the size of the housing depending upon the diameter of the pole to which the sign (2) is to be attached. Any number of differently sized individual collars can be provided depending upon the size of the pole and the size of the sign. Each collar comprises a flat flange portion (28) and a riser portion (30). The collars are arranged so that the riser portions and the flange portions are located alternately with each other so that the riser portion is located between two adjacent flange portions.

For relatively small diameter poles the flange (28) of collar (22) is merely trimmed to size to accommodate this particular pole. When the pole is of a larger diameter, such as being of greater diameter than the diameter of collar (22) the flange portion (28) of collar (24) can be cut to size to accommodate poles of generally medium diameter. When the diameter of the pole exceeds the diameter of collar (24) flange portion (28) of collar (26) can be cut to size to accommodate generally large diameter poles. If still larger poles are to be accommodated additional larger diameter collars can be provided. Thus, by producing a housing having a collar arrangement (20) with a number of individual collars or flanges of different sizes spaced apart by risers as described it is possible to simply trim or cut the flanges of the individual collars and/or the risers of the collar arrangement to the appropriate diameter to snugly fit the individual pole. It is to be noted that in other embodiments the internal surface of the collars may be shaped to fit differently profiled poles such as for example square profile poles, hexagonal section poles or other ornate or elaborately styled poles. Additionally, the semi-circular inner profile can also be used for poles of different profiles other than circular by providing gaskets, spacers or packing between the collar cut to size and the pole. In some instances, it may not be necessary for the profile of the collar to match the shape of the pole.

In the embodiments of the present invention having a collar at the base of housing (4) a similar operation can be performed to trim or otherwise cut the collar arrangement to fit the particular pole in the same or similar manner as was performed on the top collar arrangement. It is to be noted that the size of the upper collar can be different to the size of the lower collar.

Each side edge of housing (4) is provided with one form of a cooperating means or part of a cooperating means or a complementary cooperating means for cooperatively engaging with the cooperating means of another housing or with a suitable backing member. In one embodiment one side of housing (4) is provided with a first form of the cooperating means, such as a flanged extension 32 of a greater diameter or size than the remainder of the housing, whereas the other side of housing (4) is provided with a second form of the cooperating means which is adapted to be received in the flanged extension 32. The two forms can be complementary so as to be releasably securable to each other or to fit together or be interlockingly connectable together. In use the two complimentary coop rating means located on either side of the two housings can inter-react or cooperatively engage with each other to securely hold the housings together to form the sign by the two housings being interlocked together.

In one form, flanged extension 32 is shaped correspondingly to the various profiles of the housing, as shown in FIGS. 1 and 3, such as for example, a profile 34 corresponding to one or both of the collar arrangements and the side wall of the housing.

In another form of the invention the first complimentary engaging means or cooperating means comprises a slotted arrangement formed as a cavity within the side edge of the housing or as a series of cavities. The complimentary shaped other end of the housing is provided in the form of or with a tab arrangement or similar such as a tongue or other projection, protrusion or the like, which can be received in the slots or cavities. One particular form of the cooperating means is a tongue and groove arrangement or similar male/female coupling or the like. The tab and slot arrangement or whatever arrangement is adopted are provided with suitable retaining means for holding or retaining the two housings together when the tab is fully received in the slot. This ensures that the two housings cannot be readily separated from each other unless the retaining means is deactivated or similar.

A further embodiment of the cooperating means and/or complementary cooperating means includes one housing being provided with an extension along each side edge for receiving the respective side edges of the other housing within the extension. The extension, if provided, takes the form of a raised or stepped hood into which the edges of the other housing or backing member are received so that the respective dges are in side by side abutting relationship one within the other when the respective housings are interlockingly connected together. This arrangement presents a neat appearance as though the sign has the appearance of being continuous around the pole.

A band, strap, ribbon, tie, belt or similar elongate flexible member (not shown) acting as a fastener or fastening means is provided to wrap around the external surface of the collar portion at the top and at the bottom of the sign to hold the two housings together and to retain the sign on the pole 8. A suitable locking means is provided on the strap to securely connect the strap to itself so as to lock the strap in place to maintain the sign on the pole for added security. One form of the band is a metal band of the type for fastening hoses to a metal pipe or similar. Preferably the metal band is made from stainless steel. However, the elongate fastener is made from any suitable material in any suitable form.

Optionally, the sign of the present invention is provided with a means for preventing slippage of the sign axially along the pole. The anti-slipping device can take any number of different forms. One particular form is a ring, loop, hoop or the like which can be attached to the pole to fit inside the collar arrangement (22). Another form of the anti-slip device could be a screw, bolt or similar extending radially outwardly from the pole for contact with the inner surface of any one of the collars of the collar arrangement (22).

Alternatively, a suitable clamp or similar could be provided to clamp the housing to the pole, including an external clamp located outside the housing or an internal clamp located within the housing.

The housing of the present invention may be made from any suitable material, however, durable plastics material is the preferred material from which the housing is made. Typical examples of the material include polyurethane, ABS plastics, stabilised plastics, fibreglass or the like. In one form, the road sign can be manufactured from recycled or reclaimed materials or the like.

If required a gasket of resilient or flexible material is provided between the inner surface of the collar and the pole to ensure a tight fit between the sign and the pole and to weatherproof the inside of the sign, particularly if the sign is self powered or provided with a power supply or electronics located within the housing.

In forming the sign of the present invention first the anti-slip device, if used, and in which ever form it is used, is securely attached to the pole at a location which is to be covered up or hidden by sign (2) when in its final position. The particular collar of the upper and/or lower collar arrangements of each of the housings is selected and cut and trimmed to size in accordance with the diameter and/or profile of the pole to which the sign is being attached. The two housings forming the sign are placed against or otherwise fitted to opposite sides of the pole and interconnected together by their respective cooperating and/or complementary cooperating means, such as for example the respective tongues, tabs or side extensions 32 being received in or alongside the respective slots, grooves or the like, or in abutting relationship with the side flanges. The final position of the sign is determined so that the display panel faces in the correct direction or orientation on the pole at the correct height to provide the information and the strap is securely fastened to the top and a further strap fastened to the bottom of the sign to hold the two interconnected housings together and to assist in securing the sign to the pole. Thus, a sign can be located at the correct height on an existing pole without having to provide an additional pole to support th sign. Therefore, there is no extra pole to add to the existing over-crowded streetscape.

The signs illustrated in FIGS. 4 to 10 which are different alternative forms of the housings and signs, will now be described.

In FIG. 4 there is shown a top perspective view of another form of the sign of the present invention made up from three substantially identical housings in which each housing forms one side of a substantially equilateral triangle surrounding the pole. In this form of the sign three substantially identical housings 40,42,44 are interconnected together to form the triangular sign. Display panels can be provided in any one or all of the housings. It is to be noted that the cooperating means or similar are not shown in FIGS. 4 to 10.

Similarly, in FIG. 5, there is shown a top plan view of a substantially diamond shaped arrangement consisting of four housings 40,42,44,46 interconnected together to form the diamond shaped sign. Again, up to four display panels can be provided. Further, it is to be noted that each display panel can be subdivided into different sections in which there is different indicia on each section.

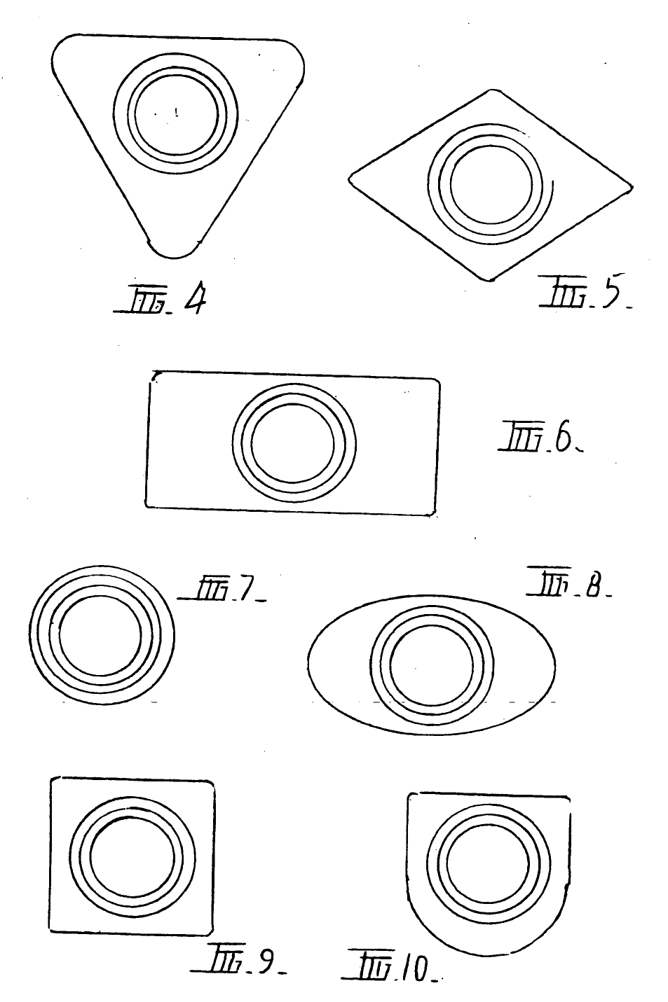

FIG. 6 illustrates a still further form of the sign of the present invention which is a substantially rectangular sign having two relatively longer sides and two relatively shorter sides. The two relatively longer sides form the longitudinal sides of the rectangle where as the two relatively shorter sides form the transverse sides of the rectangle. In this embodiment, housings 40,44 are substantially identical to each other, whereas housings 42,46 are substantially identical to each other. The two pairs of housings differ from each other owing to their different respective lengths. Display panels can be provided in all four sides or can be provided in the two longer sides or on the two shorter sides depending upon the specific indicia displayed by this form of the sign.

In FIG. 7, there is shown a circular sign similar to that shown in FIGS. 1 to 3 in which two substantially semi-circular housings are interconnected together to form the circular sign.

Similarly, in FIG. 8 there is shown a substantially elliptical sign in which two semi-elliptical housings 40,42 are interconnected together on either opposite side of the pole to form the elliptical housing.

In FIG. 9, there is shown a top-plan view of a square sign made from four identical housings 40,42,44,46 interconnected together. Again, each housing may be provided with a display panel or only some of the housings may have a display panel. It is to be noted that the display panels can be the same or different.

FIG. 10 is a top-plan view of a variation of FIG. 9 in which there are three identical planar housings and a fourth different shaped housing being typically a semi-circular housing or curved housing 46 which can be interconnected so as to form a generally semi-circular shaped sign. Alternatively, an open sided housing is provided to interconnect with the semi-circular housing.

Advantages of the present invention are that the housings are essentially a one-size-fits-all which means the housings can be sized by installers on site by selectively adjusting the collar portions of the signs in accordance with the size and/or shape of the posts to which the signs are attached. This will dispense with the need to erect new signs to have their own support elements as existing support elements can be used.

The signs can be located on any convenient or suitable support element. The signs of the present invention allow flexibility in making the signs and in the positioning of the signs.

The described arrangement has been advanced by explanation and many modifications may be made without departing from the spirit and scope of the invention which includes every novel feature and novel combination of features herein disclosed.

Those skilled in the art will appreciate that th invention described herein is susceptible to variations and modifications other than those specifically described. It is understood that the invention includes all such variations and modifications which fall within the spirit and scope.

1. A housing adapted for use as or in forming a sign for presenting or displaying indicia when attached to a support element, said housing including:
a contact portion allowing the housing to contact the support element in use to assist in forming a sign;
a display portion for displaying or presenting the indicia in use of the sign; and
a means for fastening the housing to the support element,
wherein the size of the contact portion is selectively adjustable to accommodate attaching the housing to differently sized and/or styled support elements.

2. A housing according to claim 1, further comprising:
a cooperating means for cooperatively engaging with a complementary cooperating means of another member to further assist in attaching the housing to the support element to form the sign.

3. A housing according to claim 2, in which the another member is another housing or a backing member or element.

4. A housing according to claim 1, in which the contact portion is located either at or towards the top or upper edge of the housing, or at or towards the base or lower edge of the housing, or at or towards both the top and bottom of the housing.

5. A housing according to claim 1, in which the contact position is a collar arrangement comprising at least two collar portions in which the collars are arranged substantially parallel and substantially concentric in stepped relationship to each other.

6. A housing according to claim 5, in which the collar arrangement is selectively adjustable by adjusting one or other of the collar portions.

7. A housing according to claim 6, in which the adjustability of the collar is effected by selecting an appropriately sized collar and cutting or trimming the collar to size to fit the support element.

8. A housing according to claim 7, in which the collar arrangement comprises alternatively arranged flanges and risers, in which at least one riser is located between adjacent flanges and at least one flange is located between adjacent risers, in which one of the flanges is cut and/or trimmed to size to selectively adjust the size of the collar arrangement.

9. A housing according to claim 1, in which the display panel is provided with a pocket into which is received a sheet containing the indicia to be displayed by the sign.

10. A housing according to claim 5, in which the fastening means is an elongate flexible member such as a band, strap, ribbon, tie, belt or similar which wraps around the external surface of the collar portion at the top and/or bottom of the sign to hold the two housings together to form the sign so as to retain the sign on the pole.

11. A housing according to claim 2, in which the cooperating means includes a projecting means and a receiving means complementary to each other, so that the projecting means is received in the receiving means for holding the housing to another housing to form a sign, said housings being located about the support element.

12. A housing according to claim 11, in which the cooperating means is a tongue and groov arrangement or a tab and slot arrangement or an extension and cavity arrangement.

13. A housing according to claim 11, in which the one housing is provided with both parts of the cooperating means, being the projecting means and the receiving means, such that one part of the cooperating means is located at, towards or along one side or side edge of the housing and the other part of the cooperating means is located at, towards or along the other side or side edge of the housing.

14. A housing according to claim 1, further comprising an anti-slipping device for attachment to the support element prior to fitting one or more housings to the support element.

15. A housing according to claim 5, further comprising a gasket of resilient or flexible material for location between the collar arrangement and the support element.

16. A housing according to claim 1, in which the support element is a pole, post or similar.
